(19) United States
(12) Patent Application Publication
(10) Pub. No.: US 2026/0371087 A1
(43) Pub. Date: Nov. 19, 2026

(54) PRIVATE NETWORK SLICE PROVISIONING IN WIRELESS COMMUNICATION NETWORKS

(71) Applicant: T-MOBILE INNOVATIONS LLC, Overland Park, KS (US)

(72) Inventors: Anis Adil Anis, Bay Point, CA (US); Nancy Lynne Atkinson, Raymore, MO (US); Brent Matthew Johnston, Ardmore, AL (US); Cristian Asandului, Snoqualmie, WA (US)

(21) Appl. No.: 19/206,827

(22) Filed: May 13, 2025

(51) Int. Cl. H04W 12/08; H04W 8/20; H04W 48/18

(52) U.S. Cl. CPC H04W 12/08; H04W 8/20; H04W 48/18

(57) ABSTRACT

Various embodiments include a system that comprises an Access and Mobility Management Function (AMF), a Unified Data Management (UDM), a Network Exposure Function (NEF), and an Application Function (AF) of a wireless communication network. The NEF receives a slice authorization request for a user device from an Application Server (AS) associated with a private data network over an AF. The NEF exposes the slice authorization request to the UDM. The UDM updates a subscriber profile of the user device to authorize the user device to use a private network slice associated with the private data network based on the slice authorization request. The AMF indicates a slice Identifier (ID) for the private network slice to the user device.

### TECHNICAL FIELD

Various embodiments of the present technology relate to network slicing, and more specifically, to provisioning user devices to use private network slices.

### BACKGROUND

Wireless communication networks provide wireless data services to wireless user devices. Exemplary wireless data services include voice calling, video calling, internet-access, media-streaming, online gaming, social-networking, and machine-control. Exemplary wireless user devices comprise phones, computers, vehicles, robots, and sensors. Radio Access Networks (RANs) exchange wireless signals with the wireless user devices over radio frequency bands. The wireless signals use wireless network protocols like Fifth Generation New Radio (5GNR), Long Term Evolution (LTE), Institute of Electrical and Electronic Engineers (IEEE) 802.11 (WIFI), and Low-Power Wide Area Network (LP-WAN). The RANs exchange network signaling and user data with network elements that are often clustered together into wireless network cores over backhaul data links. The core networks execute network functions to provide wireless data services to the wireless user devices.

Wireless communication networks implement network slicing to serve wireless user devices. A network slice is a type of network partition that groups a set of RAN and core network resources that have capabilities to provide one or more service types. Network slices may be configured to provide low-latency services, media streaming services, Internet-of-Things (IoT) services, and the like. Network slices comprise features like maximum allowed latency, Guaranteed Bit Rate (GBR), Quality-of-Service (QoS) level, dedicated bandwidth, priority scheduling, and/or other features to support the one or more service types. Exemplary slice types include Ultra-Reliable Low Latency Communication (URLLC), Enhanced Mobile Broadband (eMBB), Massive Machine Type Communications (mMTC), Vehicle-to-Everything (V2X), Fixed Wireless Access (FWA), and private. By implementing network slicing, wireless communication networks optimize the computing and radio resources for specific service types thereby enhancing the overall user experience.

### OVERVIEW

This Overview is provided to introduce a selection of concepts in a simplified form that are further described below in the Technical Description. This summary is not intended to identify key features or essential features of the claimed subject matter, nor is it intended to be used as an aid in determining the scope of the claimed subject matter.

Various embodiments of the present technology relate to solutions for network slicing. Some embodiments comprise a method. The method comprises receiving a slice authorization request for a user device of a wireless communication network from a private data network. The method further comprises updating a subscriber profile of the user device to authorize the user device to use a private network slice associated with the private data network based on the slice authorization request. The method further comprises indicating the slice Identifier (ID) for the private network slice to the user device.

Some embodiments comprise a method. The method comprises receiving, by a Network Exposure Function (NEF), a slice authorization request for a user device from an Application Server (AS) associated with a private data network over an Application Function (AF). The method further comprises exposing, by the NEF, the slice authorization request to a Unified Data Management (UDM). The method further comprises updating, by the UDM, a subscriber profile of the user device to authorize the user device to use a private network slice associated with the private data network based on the slice authorization request. The method further comprises indicating, by an Access and Mobility Management Function (AMF), a slice Identifier (ID) for the private network slice to the user device.

Some embodiments comprise a system. The system comprises an AMF, a UDM, a NEF, and an AF of a wireless communication network. The NEF receives a slice authorization request for a user device from an AS associated with a private data network over an AF. The NEF exposes the slice authorization request to the UDM. The UDM updates the subscriber profile of the user device to authorize the user device to use a private network slice associated with the private data network based on the slice authorization request. The AMF indicates a slice ID for the private network slice to the user device.

### DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an example of a communication network to provision user devices to use private network slices.

FIG. 2 illustrates a first exemplary operation of the communication network to provision user devices to use private network slices.

FIG. 3 illustrates a second exemplary operation of the communication network to provision user devices to use private network slices.

FIG. 4 illustrates a third exemplary operation of the communication network to provision user devices to use private network slices.

FIG. 5 illustrates an example of a Fifth Generation (5G) communication network to provision user devices to use private network slices.

FIG. 6 illustrates an example of a User Equipment (UE) in the 5G communication network that provisions user devices to use private network slices.

FIG. 7 illustrates an example of a 5G Radio Access Network (RAN) in the 5G communication network that provisions user devices to use private network slices.

FIG. 8 illustrates an example of a 5G data center in the 5G communication network that provisions user devices to use private network slices.

FIG. 9 further illustrates an example of a 5G data center in the 5G communication network that provisions user devices to use private network slices.

FIG. 10 illustrates an exemplary operation of the 5G communication network to provision user devices to use private network slices.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### TECHNICAL DESCRIPTION

A network slice is a type of network partition that groups a set of Radio Access Network (RAN) and core network resources that have capabilities to provide one or more service types. When user devices attach to the communication network over a wireless access node (e.g., a gNodeB), the user device may be assigned to a network slice based on the device's subscription on the network, the device's capabilities, the device's session requirements, and device slice requests. Typically, user devices are assigned to network slices that the user devices are authorized to use and that have capabilities that align with the capabilities and session requirements of the user devices. Each network slice comprises a suite of network slice features like maximum allowed latency, Guaranteed Bit Rate (GBR), priority Quality-of-Service (QoS), dedicated bandwidth, priority scheduling, and/or other features to support service on the network slice. For example, an Ultra-Reliable Low-Latency Communications (URLLC) slice may comprise a maximum allowed latency slice feature to ensure user device communications on the slice are within an operator defined latency range.

Conventional wireless communication networks route user data for user devices to different data networks based on data network identifiers provisioned to the user devices. Data networks may be public data networks (e.g., the Internet, etc.) or private data networks (e.g., an enterprise network, residential network, government network, etc.). Exemplary data network identifies include Access Point Name (APN) and Data Network Name (DNN). To access a particular data network, the user device includes the APN/DNN for that network in the session request sent to the wireless communication network. APNs and DNNs are provisioned network values. As such, for a user device to be able to access a new data network, the user device is reprovisioned with the APN/DNN for that network. Reprovisioning APNs/DNNs to user devices is a time consuming and tedious process. Unfortunately, conventional wireless communication networks do not effectively and efficiently enable user device access to new data networks.

To overcome the above-described problems in conventional wireless communication networks, various embodiments of the present technology relate to provisioning user devices to use private network slices. The private network slice comprises one or more RAN elements and one or more core network elements that provide a dedicated data path to a private data network. For example, the private network slice may pride a user plane link to a gateway associated with the private data network. The wireless communication network receives a request to authorize the user device to use the private network slice from a system (e.g., an Application Server (AS)) associated with the private data network. The communication network modifies the user device's subscriber profile to include an authorization for the slice ID of the private network slice. The wireless communication network wirelessly indicates the slice ID to the user device to notify the user device that it is authorized to use the private network slice. Subsequently, the user device transfers a session request to the wireless communication network. The session request includes the slice ID for the private network slice. The wireless communication network establishes a data session for the user device on the private network slice based on the slice ID included in the request and the slice ID authorization in the user device's subscriber profile. The user device exchanges user data with the private data network over the private network slice. Advantageously, the wireless communication network effectively and efficiently enables the user device to access a private data network without having to reprovision the user device with the APN/DNN for the private data network. This improves the overall user experience. Now referring to the Figures.

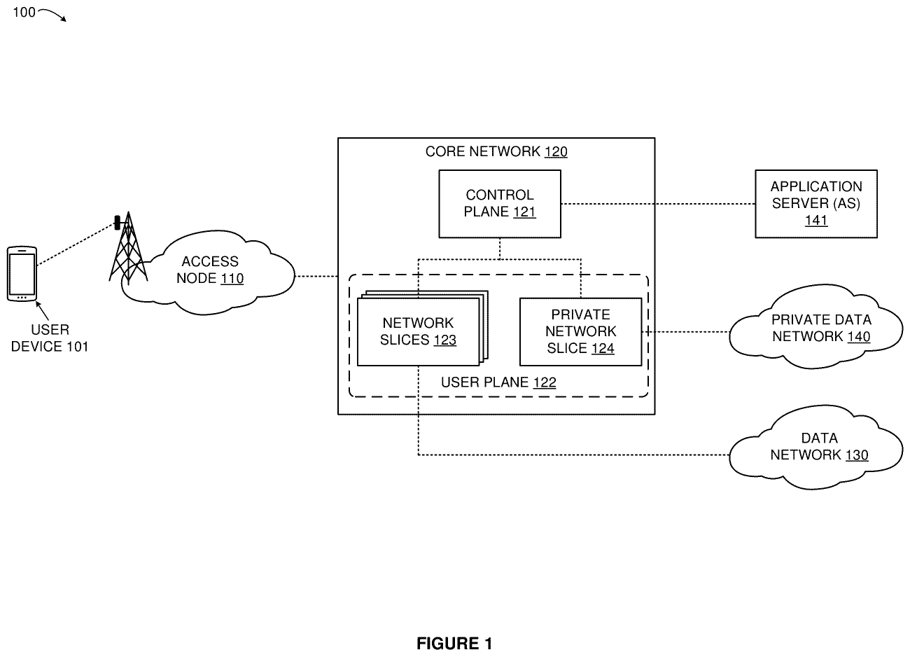

FIG. 1 illustrates communication network 100 to provision user devices to use private network slices. Communication network 100 provides services like media-streaming, media-broadcasting, internet-access, voice/video calling, text messaging, online gaming, social media, machine communications, remote device control, and/or some other wireless communications product. Communication network 100 comprises user device 101, access node 110 which is an example of a RAN, core network 120, data network 130, private data network 140, and Application Server (AS) 141. Core network 120 comprises control plane 121 and user plane 122. User plane 122 comprises network slices 123 and private network slice 124. In other examples, communication network 100 may comprise additional or different elements than those illustrated in FIG. 1.

Various examples of network operation and configuration are described herein. In some examples, AS 141 and user device 101 are associated with private data network 140. Private data network 140 is only accessible to authorized devices. For example, private data network 140 may be representative of an enterprise or governmental network and user device 101 may belong to an employee of the enterprise or governmental agency that operates private data network 140. Private network slice 124 comprises one or more RAN and one or more user plane network elements provide an end-to-end connection between user devices and a gateway of private data network 140. Private network slice 124 segregates traffic between private data network 140 and user devices from traffic between data network 130 and other user devices in communication network 100. For example, private network slice 124 may route traffic to private data network 140 without having to provision user devices with the DNN of private data network 140.

Control plane 121 receives a slice authorization request from AS 141 to authorize user device 101 to use private network slice 124. The request may include information to identify user device 101 and private network slice 124. Exemplary user device identifiers include subscriber Identifier (ID), International Mobile Subscriber Identifier (IMSI), Subscriber Concealed Identifier (SUCI), Subscriber Permanent Identifier (SUPI), and the like. Exemplary slice identifiers include slice ID, Single-Network Slice Selection Assistance Information (S-NSSAI), slice instance ID, and the like. Control plane 121 accesses user device 101's subscriber profile and adds and authorization to use private network slice 124. For example, control plane 121 may write the S-NSSAI for private network slice 124 to a list of allowed S-NSSAIs included in user device 101's subscriber profile. Control plane 121 transfers signaling to user device 101 over access node 110 that includes the slice ID of private network slice 124 and/or some other indication to notify user device 101 that it is allowed to access private network slice 124.

Subsequently, user device 101 transfers a session request that includes the slice ID for private network slice 124 to control plane 121 over access node 110. Control plane 121 accesses user device 101's subscriber profile and determines user device 101 is authorized to use private network slice 124. Control plane 121 directs user plane 122 to serve user device over private network slice 124. Control plane 121 directs user device 101 to begin its data session. User device 101 exchanges user data with private data network 140 over an end-to-end connection that traverses access node 110 and private network slice 124.

Advantageously, communication network 100 effectively provisions a user device to use a private network slice in response to receiving a third-party request. Moreover, communication network 100 efficiently enables the user device to access new data networks (e.g., the private data network) without having to reprovision the user device with the APN/DNN for the new data networks.

User device 101 may comprise a phone, computer, vehicle, drone, robot, sensor, or another type of data appliances with wireless and/or wireline communication circuitry. User device 101 and access node 110 may communicate over links using wireless/wireline technologies like Sixth Generation Radio (6GR), Fifth Generation New Radio (5GNR), Long Term Evolution (LTE), Institute of Electrical and Electronic Engineers (IEEE) 802.11 (WiFi), IEEE 802.3 (Ethernet), Low-Power Wide Area Network (LP-WAN), Bluetooth, and/or some other type of wireless and/or wireline networking protocol. The wireless technologies use electromagnetic frequencies in the low-band, mid-band, high-band, or some other portion of the electromagnetic spectrum. The wired connections comprise metallic links, glass fibers, and/or some other type of wired interface.

Access node 110 may comprise a tower (e.g., to mount a radio at elevation), another type of mounting structure (e.g., a building), or no mounting structure at all. Access node 110 may comprise a RAN node, Sixth Generation (6G) RAN node, Fifth Generation (5G) RAN node, LTE RAN node, gNodeB, eNodeB, Narrow Band Internet-of-Things (NB-IoT) access node, trusted non-Third Generation Partnership Project (3GPP) access node, untrusted non-3GPP access node, Low Power-Wide Area Network (LP-WAN) base station, wireless relay, WiFi hotspot, Bluetooth access node, Ethernet access node, and/or another type of wireless or wireline network transceiver. Although access node 110 is illustrated as comprising a terrestrial access network, in some examples access node 110 may comprise a non-terrestrial (e.g., satellite based) access node. Access node 110 exchanges network signaling and user data with network functions clustered together into core network 120. Access node 110 is connected to core network 120 over one or more backhaul data links. Access node 110 and core network 120 may communicate via edge networks like internet backbone providers, edge computing systems, or another type of edge system to provide the backhaul data and signaling links between access node 110 and core network 120.

Access node 110 may comprise Radio Units (RUs), Distributed Units (DUs) and Centralized Units (CUs). The RUs may be mounted at elevation and have antennas, modulators, signal processors, and the like. The RUs are connected to the DUs which are usually nearby network computers. The DUs handle lower wireless network layers like the Physical Layer (PHY), Media Access Control (MAC), and Radio Link Control (RLC). The DUs are connected to the CUs which are larger computer centers that are closer to core network 120. The CUs handle higher wireless network layers like the Radio Resource Control (RRC), Service Data Adaption Protocol (SDAP), and Packet Data Convergence Protocol (PDCP). The CUs are coupled to network functions in core network 120. Alternatively, access node 110 may comprise RUs and Baseband Units (BBUs). The BBUs are usually nearby network computers and handle network layers like RRC, SDAP, PDCP, RLC, MAC, and PHY. The BBUs are coupled to network functions in core network 120.

Core network 120 is representative of computing systems that provide wireless data services to user device 101 over access node 110. Exemplary computing systems comprise Network Function Virtualization Infrastructure (NFVI) systems, data centers, server farms, cloud computing networks, hybrid cloud networks, and the like. Core network 120 may comprise a 3GPP core network architecture like Sixth Generation Core (6GC), Fifth Generation Core (5GC), Evolved Packet Core (EPC), and/or another type of 3GPP core network architecture. Access node 110, core network 120, data network 130, private data network 140, and AS 141 communicate over various links that use metallic links, glass fibers, radio channels, or some other communication media. The links use 6GC, 5GC, EPC, Ethernet, Time Division Multiplex (TDM), Data Over Cable System Interface Specification (DOCSIS), Internet Protocol (IP), General Packet Radio Service Transfer Protocol (GTP), 6GR, 5GNR, LTE, WiFi, virtual switching, inter-processor communication, bus interfaces, and/or some other data communication protocol. The computing systems of core network 120 store and execute the network functions/entities to form control plane 121 and user plane 122. Exemplary control plane network functions include Access and Mobility Management Function (AMF), Session Management Function (SMF), Network Slice Selection Function (NSSF), Unified Data Management (UDM), Unified Data Registry (UDR), Network Exposure Function (NEF), and Application Function (AF), and the like. Exemplary user plane network functions include User Plane Function (UPF) and the like.

Network slices are representative of collections of network elements (e.g., UPFs, control plane network functions, access nodes, etc.) with capabilities to support different service types over access node 110. For example, a first network slice may comprise low-latency capabilities to support low-latency data sessions while another network slice may comprise high-uplink bandwidth capabilities to support media broadcasting sessions. Exemplary network slice types (of which network slices 123 are representative of) include Enhanced Mobile Broadband (eMBB), Ultra-Reliable Low-Latency Communication (URLLC), Massive Machine-Type Communications (mMTC) slice, Vehicle To Everything (V2X), Fixed Wireless Access (FWA), security, and the like. Private network slice 124 may comprise one of these slice types or may comprise a custom slice type with slice parameters (e.g., latency, bandwidth capability, security, etc.) customized from traffic exchanged with private data network 140. Network slices 123 and private network slice 124 may comprise portions of user plane 122, portions of control plane 121, portions of access node 110, or may reside in other locations within communication network 100.

Data network 130 and private data network 140 comprise application servers, gateways, routers, Content Distribution Networks (CNDs) and/or other communication devices to participate in data sessions with user device 101. For example, private data network 140 may comprise an application server that hosts the server-side component of a user application executing on user device 101. Data network 130 is representative of a public data network (e.g., the Internet) or while private data network 140 is representative of a private network (e.g., an enterprise network, a government network, a private residential network, etc.). Core network 120, data network 130, and private data network 140 may communicate via links provided by internet backbone providers, edge computing services, and/or other communication services that provide the data links between core network 120, data network 130, and private data network 140.

User device 101 and access node 110 comprise antennas, amplifiers, filters, modulation, analog/digital interfaces, microprocessors, software, memories, transceivers, bus circuitry, and the like. User device 101, access node 110, core network 120, data network 130, private data network 140, and AS 141 comprise microprocessors, software, memories, transceivers, bus circuitry, and the like. The microprocessors comprise Digital Signal Processors (DSP), Central Processing Units (CPU), Graphical Processing Units (GPU), Application-Specific Integrated Circuits (ASIC), Field Programmable Gate Array (FPGA), Analog Processing Units (APUs), and/or the like. The memories comprise Random Access Memory (RAM), Solid State Drives (SSDs), Hard Disk Drives (HDDs), Non-Volatile Memory Express (NVMe) SSDs, and/or the like. The memories store software like operating systems, user applications, radio applications, and network functions. The microprocessors retrieve the software from the memories and execute the software to drive the operation of communication network 100 as described herein.

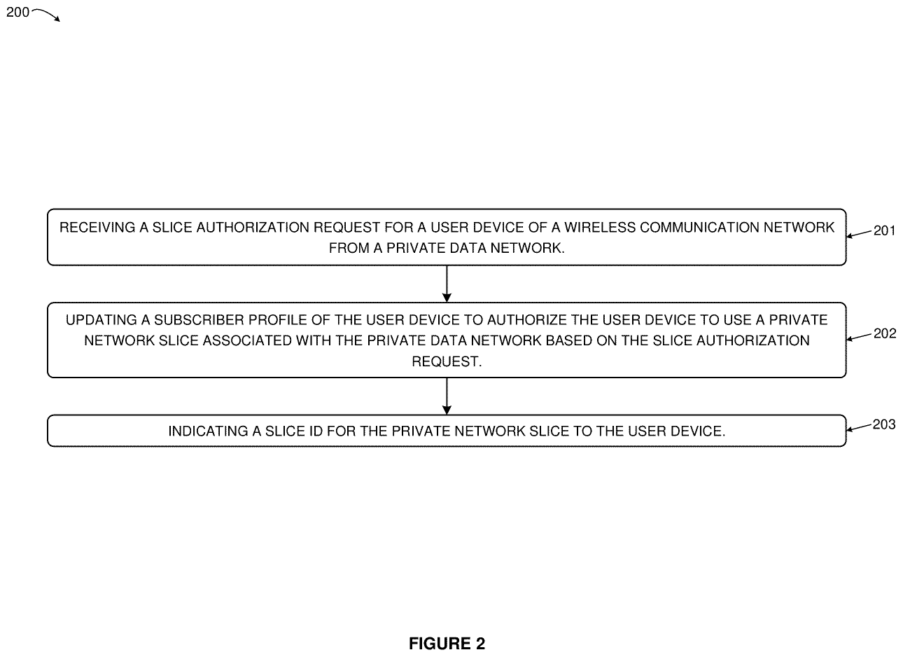

FIG. 2 illustrates process 200. Process 200 comprises an exemplary operation of communication network 100 to provision user devices to use private network slices. Process 200 may vary in other examples. The operations of process 200 comprise receiving a slice authorization request for a user device of a wireless communication network from a private data network (step 201). The operations further comprise updating a subscriber profile of the user device to authorize the user device to use a private network slice associated with the private data network based on the slice authorization request (step 202). The operations further comprise indicating a slice ID for the private network slice to the user device (step 203).

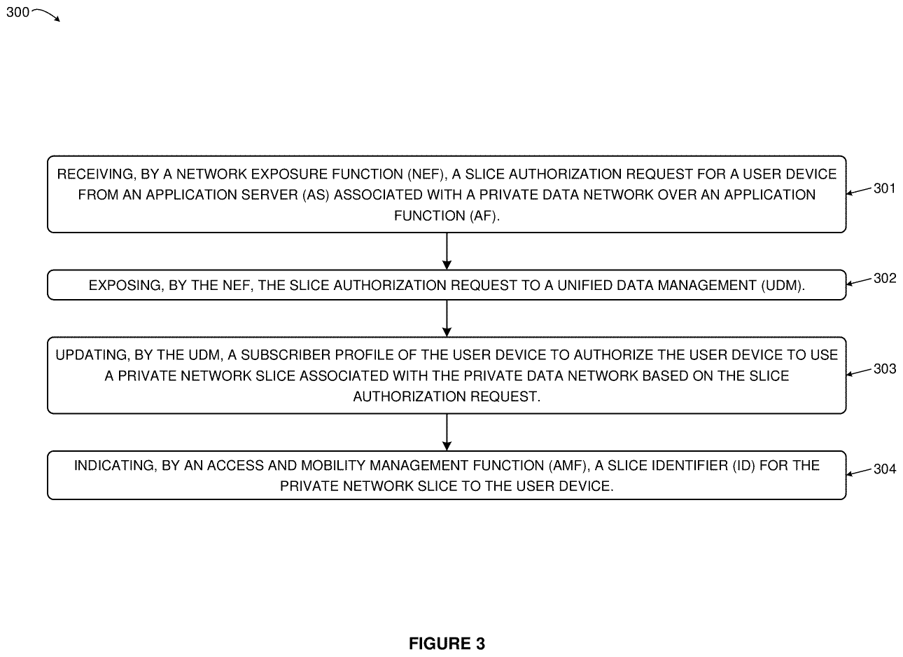

FIG. 3 illustrates process 300. Process 300 comprises an exemplary operation of communication network 100 to provision user devices to use private network slices. Process 300 comprises an example of process 200 illustrated in FIG. 2, however process 200 may differ. Process 300 may vary in other examples. The operations of process 300 comprise receiving, by a NEF, a slice authorization request for a user device from an AS associated with a private data network over an AF (step 301). The operations further comprise exposing, by the NEF, the slice authorization request to a UDM (step 302). The operations further comprise updating, by the UDM, a subscriber profile of the user device to authorize the user device to use a private network slice associated with the private data network based on the slice authorization request (step 303). The operations further comprise indicating, by an AMF, a slice ID for the private network slice to the user device (step 304).

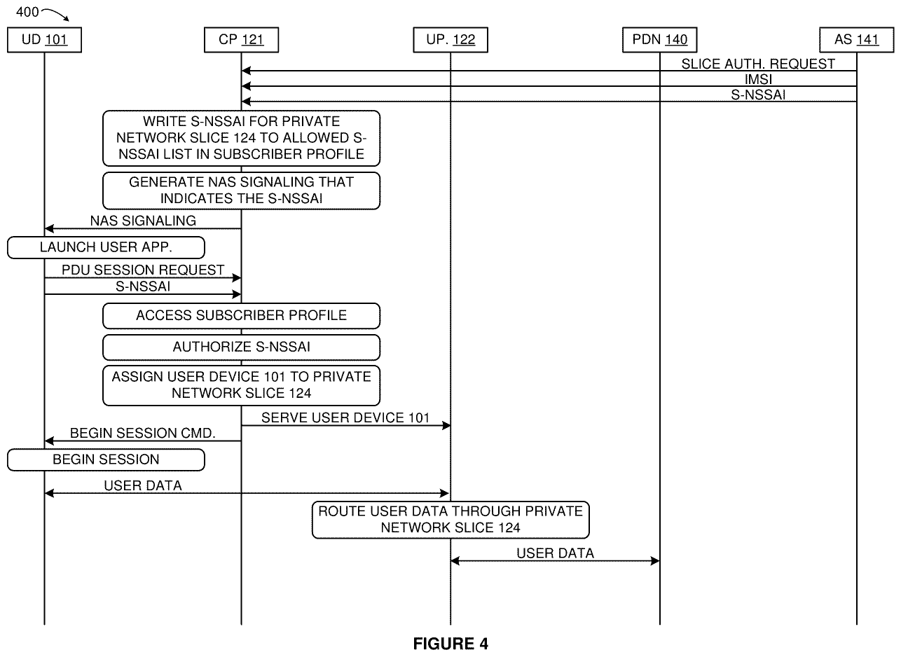

FIG. 4 illustrates process 400. Process 400 comprises an exemplary operation of communication network 100 to provision user devices to use private network slices. Process 400 comprises an example of process 200 illustrated in FIG. 2 and process 300 illustrated in FIG. 3, however processes 200 and 300 may differ. Process 400 may vary in other examples. In some examples, user device 101 becomes associated with private data network (PDN) 140. For example, the user of user device (UD) 101 may be hired by the commercial enterprise operating private data network 140. AS 141 transfers a slice authorization request for user device 101 to control plane (CP) 121 to onboard user device 101 to private network slice 124. The slice authorization request includes the IMSI of user device 101 and the S-NSSAI of private network slice 124.

Control plane 121 receives the slice authorization request from AS 141. Control plane 121 accesses the subscriber profile of user device 101 based on the IMSI included in the request. Control plane 121 writes the S-NSSAI received in the request to a list of allowed S-NSSAI included in the subscriber profile. Control plane 121 generates Non-Access Stratum (NAS) signaling that encodes or otherwise indicates the S-NSSAI for private network slice 124. Control plane 121 transfers the NAS signaling to access node 110. Access node 110 wirelessly transfers the NAS signaling to user device 101. User device 101 stores the S-NSSAI for private network slice 124 in memory.

User device 101 receives an input launching a user application. In response, user device 101 transfers a Protocol Data Unit (PDU) session request to control plane 121 over access node 110. The PDU session request includes the S-NSSAI for private network slice 124 as a requested S-NSSAI. Control plane 121 accesses user device 101's subscriber profile and compares the requested S-NSSAI for private network slice 124 to the list of allowed S-NSSAIs which includes the S-NSSAI for private network slice 124. Control plane 121 authorizes user device 101 for service on private network slice 124 based on the comparison. Control plane 121 directs user plane 122 to serve user device 101 on private network slice 124 and transfers a begin session command (CMD) to user device 101 over access node 110. User device 101 begins the session and exchanges user data with user plane 122. User plane 122 routes the user data through private network slice 124 to private data network 140.

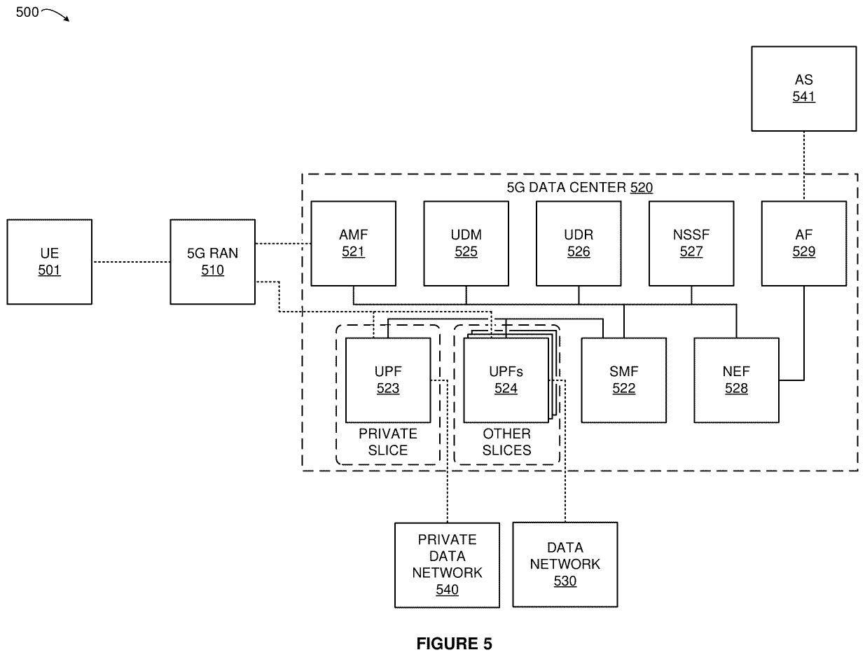

FIG. 5 illustrates 5G communication network 500 to provision user devices to use private network slices. 5G communication network 500 comprises an example of communication network 100 illustrated in FIG. 1, however communication network 100 may differ. 5G communication network 500 comprises UE 501, 5G RAN 510, 5G data center 520, data network 530, private data network 540, and AS 541. 5G data center 520 comprises AMF 521, SMF 522, UPF 523, UPFs 524, UDM 525, UDR 526, NSSF 527, NEF 528, and AF 529. Other network functions and network entities like Policy Control Function (PCF), Authentication Server Function (AUSF), Charging Function (CHF), Home Subscriber System (HSS), Home Subscriber Register (HLR), Short Message Service Function (SMSF), Equipment Identity Register (EIR), and Session Communication Proxy (SCP) are typically present in 5G data center 520 but are omitted for clarity. 5G data center 520 comprises a private network slice and other network slices. The other network slices may comprise eMBB slices, URLLC slices, FWA slices, V2X slices, mMTC slices, and the like. The private network slice may comprise one of these slice types, a different slice type, or a custom slice type. UPF 523 forms the private network slice and UPFs 524 form the other network slices. Although illustrated as only comprising UPFs, the private slice and other slices may comprise other network elements in 5G communication network 500. Moreover, some elements may be shared between different ones of the private slice and other network slices. For example, the private slice and one or more of the other slices may both comprise SMF 522. In other examples, 5G communication network 500 may comprise different or additional elements than those illustrated in FIG. 5.

In some examples, the private network slice provides a dedicated data channel for communication with private data network 540. UE 501 becomes associated with an enterprise that operates private data network 540. For example, the user of UE 501 may be hired by the enterprise that operates private data network 540. AS 541 is also associated with private data network 540 and obtains the IMSI of UE 501. AS 541 transfers a slice onboarding request to NEF 528 over AF 529. The slice onboarding request requests device authorization to use the private network slice, includes UE 501's IMSI, and includes the S-NSSAI of the private slice. NEF 528 receives the slice onboarding request and exposes the request to UDM 525. UDM 525 locates UE 501's subscriber profile stored by UDR 526 based on the IMSI included in the request. UDM 525 writes an update to the subscriber profile that adds the S-NSSAI included in the request to a list of allowed S-NSSAI in UE 501's subscriber profile.

UE 501 attaches to 5G RAN 510. UE 501 transfers a registration request to AMF 521 over 5G RAN 510. The registration request indicates a registration type, 5G-Global Unique Temporary Identifier (GUTI), Tracking Area Identifier (TAI), UE capabilities, PDU session requests, NSSAI requests, and the like. At this point, UE 501 is unaware that it is authorized to use the private network slice. As such, the NSSAI requests correspond to the other network slices. In response to the registration request, AMF 521 transfers a NAS identity request to UE 501 over 5G RAN 510. UE 501 indicates its SUCI to AMF 521 over 5G RAN 510. AMF 521 interfaces with other network functions like UDM 525 to derive the SUPI of UE 501 and to authenticate the identity of UE 501. Typically, authentication involves presenting a random number challenge to UE 501 and matching an authentication response from UE 501 with an expected result to verify the identity of UE 501.

Responsive to the authentication, AMF 521 interfaces with UDM 525 to generate context for UE 501. The UE context defines the authorized services for UE 501. To form the context, AMF 521 requests access and mobility subscription data, SMF selection subscription data, and UE context in SMF data from UDM 525. UDM 525 retrieves the requested data from UE 501's subscriber profile stored by UDM 525 and provides the data to AMF 521. The access and mobility subscription data comprises a supported feature list for UE 501 (e.g., Quality of Service Class Indicator (QCI), Aggregate Maximum Bit Rate (AMBR), latency, voice/video calling, internet access, etc.), a General Public Subscription Identifier (GPSI) array, slice selection information, and the like. The SMF selection data comprises a supported feature list and a list of allowed S-NSSAIs and associated information. The UE context in SMF data comprises PDU session and EPC interworking information. The list of allowed S-NSSAIs includes the S-NSSAI for the private network slice included in UE 501's subscriber profile in response to the request received from AS 541. AMF 521 forms the UE context for UE 501 using the retrieved information.

AMF 521 selects NSSF 527 to select a network slice for UE 501. AMF 521 transfers a slice selection request for UE 501 to NSSF 527. The slice selection request includes the requested NSSAIs received in UE 501 registration request, the SUPI of UE 501, as well as other data like Tracking Area Identifier (TAI), Public Land Mobility Network (PLMN) ID, and the like. NSSF 527 maps the requested NSSAIs to allowed NSSAIs. NSSF 527 may determine allowed NSSAIs based on factors like the list of allowed S-NSSAIs included in UE 501's subscriber profile, availability, slice loading, provisioning information, and the like. NSSF 527 selects one or more of the other network slices available in 5G data center 520 based on the requests and the mapping and provides the selected S-NSSAIs and allowed S-NSSAIs list to AMF 521. The allowed S-NSSAIs list includes the S-NSSAI for the private network slice. At this point, NSSF 527 does not select the private network slice for UE 501 because UE 501 did not request the S-NSSAI for the private network slice. AMF 521 assigns UE 501 to the one or more of the other network slice(s) based on the response from NSSF 527. For example, if NSSF 527 generates a response that selects an eMBB slice (of the other network slices) for UE 501, AMF 521 may assign UE 501 to the eMBB slice.

AMF 521 selects SMF 522 to serve UE 501 based on SMF selection data, the policy association information, and/or the network slice(s) of UE 501. AMF 521 transfers a list of requested PDU sessions (as received during the registration request), a PDU session activation command, the SUPI, and typically other information associated with UE 501 to SMF 522. SMF 522 receives the PDU session list, session activation command, and the SUPI from AMF 521. SMF 522 allocates an IP address to UE 501 for the requested PDU session and allocates a Tunnel Endpoint Identifier (TEID) for the session. SMF 522 selects one or more of UPFs 524 to serve UE 501 based on UE 501's network slice(s). SMF 522 transfers a session modification request that includes a session endpoint identifier and TEID to the selected one(s) of UPFs 524 to set up the initial PDU session(s) for UE 501. The selected one(s) of UPFs 524 sets up a default bearer for UE 501 with 5G RAN 510. The default bearer is a link to carry IP packets for UE 501's PDU session. The selected one(s) of UPFs 524 transfers a session modification response to SMF 522 that includes the session endpoint identifier to confirm bearer setup.

SMF 522 returns a PDU session create response to AMF 521 to confirm session creation. The response includes the updated session context (e.g., allocated IP addresses, TEID, etc.). In response, AMF 521 registers UE 501 for service on 5G data center 520. AMF 521 generates a registration accept message that includes the allocated UE IP address, RAN ID, AMBR, Globally Unique AMF ID (GUAMI), PDU session ID, PDU session TEID, allowed NSSAI list (including the S-NSSAI for the private network slice), security data, and the like. AMF 521 transfers NAS signaling that includes the registration accept message to UE 501 and directs 5G RAN 510 serve UE 501.

UE 501 receives the NAS signaling carrying the registration accept message from AMF 521. 5G RAN 510 transfers an RRC reconfiguration message to UE 501 to set up data radio bearers. The message includes cell IDs, bearer configuration information, network address (e.g., the address for P-CSCF 441), and the like. UE 501 configures its radio bearers using the received information. In response, UE 501 begins its PDU session on 5G communication network 500. UE 501 exchanges user data for the PDU session with data network 530 over 5G RAN 510 and the ones of UPFs 524 in the other slices assigned to UE 501.

UE 501 detects the S-NSSAI for the private network slice included in the list of allowed S-NSSAIs received in the registration accept message. In response, UE 501 transfers a PDU session request to AMF 521 that requests the S-NSSAI for the private network slice. AMF 521 receives the request and provides the S-NSSAI to NSSF 527. NSSF 527 maps the S-NSSAI to the private network slice, determines the S-NSSAI for the private network slice is an allowed S-NSSAI, and responsively selects the S-NSSAI. NSSF 527 returns the selected S-NSSAI to AMF 521.

AMF 521 transfers a PDU session modification request to SMF 522. The PDU session modification request includes a list of active PDU sessions and the S-NSSAI for the private network slice. SMF 522 receives the request and allocates a new IP address and TEID for the session. SMF 522 selects UPF 523 to serve UE 501 based on the S-NSSAI for the private network slice. UPF 523 sets up a default bearer for UE 501 with 5G RAN 510. UPF 523 transfers a session modification response to SMF 522 that includes the session endpoint identifier to confirm bearer setup. SMF 522 returns a PDU session modification response to AMF 521 to confirm session modification. The response includes the updated session context (e.g., allocated IP addresses, TEID, etc.). AMF 521 generates a PDU session response message that includes the updated session context. AMF 521 transfers NAS signaling that includes the PDU session response message to UE 501 and directs 5G RAN 510 serve UE 501. UE 501 receives the NAS signaling carrying the PDU session response message. UE 501 begins its PDU session on the private network slice in 5G communication network 500 and ends its PDU sessions on the other network slices in 5G communication network 500. UE 501 exchanges user data for the PDU session with private data network 540 over 5G RAN 510 and UPF 523 in the private network slice assigned to UE 501.

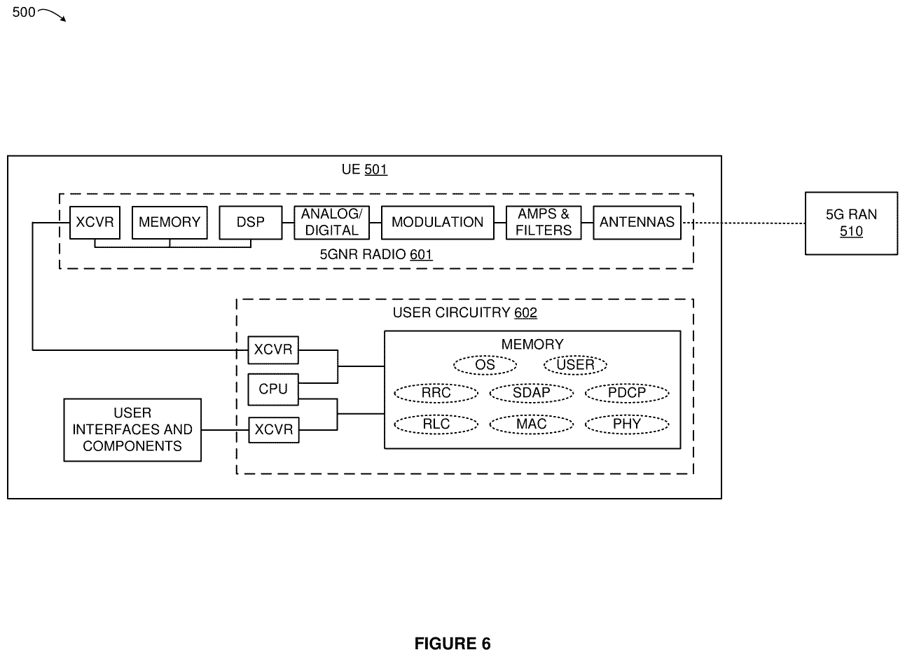

FIG. 6 illustrates UE 501 in 5G communication network 500. UE 501 comprises an example of user device 101 illustrated in FIG. 1, although user device 101 may differ. UE 501 comprises 5G radio 601 and user circuitry 602. 5G radio 601 comprises 5GNR antennas, amplifiers, filters, modulation, analog-to-digital interfaces, Digital Signal Processers (DSP), memory, and transceivers (XCVRs) that are coupled over bus circuitry. User circuitry 602 comprises memory, CPU, user interfaces and components, and transceivers that are coupled over bus circuitry.

The memory in user circuitry stores an operating system (OS), user applications (USER), and 5GNR network applications for PHY, MAC, RLC, PDCP, SDAP, and RRC. The antenna in 5G radio 601 is wirelessly coupled to 5G RAN 510 over a 5GNR link. Transceivers in 5G radio 601 are coupled to a transceiver in user circuitry 602. A transceiver in user circuitry 602 is typically coupled to user interfaces and components like displays, controllers, and memory.

In 5G radio 601, the antennas receive wireless signals from 5G RAN 510 that transport downlink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequency. The analog/digital interfaces convert the demodulated analog signals into digital signals for the DSPs. The DSPs transfer corresponding 5GNR symbols to user circuitry 602 over the transceivers. In user circuitry 602, the CPU executes the network applications to process the 5GNR symbols and recover the downlink 5GNR signaling and data. The 5GNR network applications receive new uplink signaling and data from the user applications. The network applications process the uplink user signaling and the downlink 5GNR signaling to generate new downlink user signaling and new uplink 5GNR signaling. The network applications transfer the new downlink user signaling and data to the user applications. The 5GNR network applications process the new uplink 5GNR signaling and user data to generate corresponding uplink 5GNR symbols that carry the uplink 5GNR signaling and data.

In 5G radio 601, the DSP processes the uplink 5GNR symbols to generate corresponding digital signals for the analog-to-digital interfaces. The analog-to-digital interfaces convert the digital uplink signals into analog uplink signals for modulation. Modulation up-converts the uplink analog signals to their carrier frequency. The amplifiers boost the modulated uplink signals for the filters which attenuate unwanted out-of-band energy. The filters transfer the filtered uplink signals through duplexers to the antennas. The electrical uplink signals drive the antennas to emit corresponding wireless 5GNR signals to 5G RAN 510 that transport the uplink 5GNR signaling and data.

RRC functions comprise authentication, security, handover control, status reporting, QoS, network broadcasts and pages, and network selection. SDAP functions comprise QoS marking and flow control. PDCP functions comprise security ciphering, header compression and decompression, sequence numbering and re-sequencing, de-duplication. RLC functions comprise Automatic Repeat Request (ARQ), sequence numbering and resequencing, segmentation and resegmentation. MAC functions comprise buffer status, power control, channel quality, Hybrid ARQ (HARQ), user identification, random access, user scheduling, and QoS. PHY functions comprise packet formation/deformation, windowing/de-windowing, guard-insertion/guard-deletion, parsing/de-parsing, control insertion/removal, interleaving/de-interleaving, Forward Error Correction (FEC) encoding/decoding, channel coding/decoding, channel estimation/equalization, and rate matching/de-matching, scrambling/descrambling, modulation mapping/de-mapping, layer mapping/de-mapping, precoding, Resource Element (RE) mapping/de-mapping, Fast Fourier Transforms (FFTs)/Inverse FFTs (IFFTs), and Discrete Fourier Transforms (DFTs)/Inverse DFTs (IDFTs).

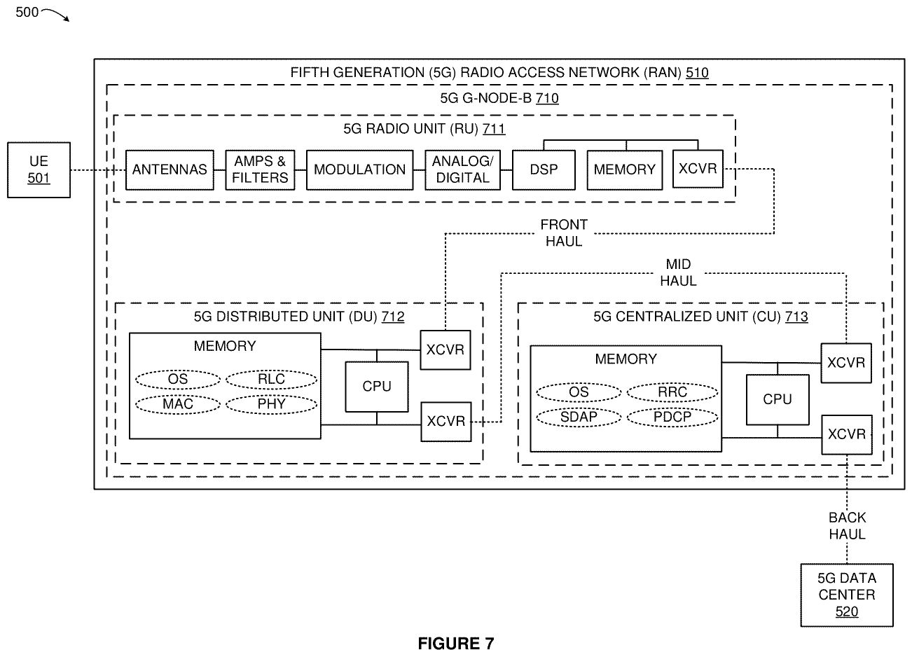

FIG. 7 illustrates 5G RAN 510 in 5G communication network 500. 5G RAN 510 comprises 5G gNodeB 710. 5G gNodeB 710 comprise 5G RU 711, 5G DU 712, and 5G CU 713. RU 711 comprises 5GNR antennas, amplifiers, filters, modulation, analog-to-digital interfaces, DSP, memory, and transceivers (XCVRs) that are coupled over bus circuitry. UE 501 is wirelessly coupled to antennas in RU 711 over 5GNR links. Transceivers in RU 711 are coupled to transceivers in DU 712 over fronthaul links like enhanced Common Public Radio Interface (eCPRI). The DSPs in RU 711 execute their operating systems and radio applications to exchange 5GNR signals with UE 501 and to exchange 5GNR data with DU 712.

For the uplink, the antennas in RU 711 receive wireless signals from UE 501 that transport uplink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequencies. The analog/digital interfaces convert the demodulated analog signals into digital signals for the DSPs. The DSPs transfer corresponding 5GNR symbols to DU 712 over the transceivers.

For the downlink, the DSPs receive downlink 5GNR symbols from DU 712. The DSPs process the downlink 5GNR symbols to generate corresponding digital signals for the analog-to-digital interfaces. The analog-to-digital interfaces convert the digital signals into analog signals for modulation. Modulation up-converts the analog signals to their carrier frequencies. The amplifiers boost the modulated signals for the filters which attenuate unwanted out-of-band energy. The filters transfer the filtered electrical signals through duplexers to the antennas. The filtered electrical signals drive the antennas to emit corresponding wireless signals to UE 501 that transport the downlink 5GNR signaling and data.

DU 712 comprises memory, CPU, and transceivers that are coupled over bus circuitry. The memory in DU 712 stores operating systems and 5GNR network applications like PHY, MAC, and RLC. CU 713 comprises memory, CPU, and transceivers that are coupled over bus circuitry. The memory in CU 713 stores an operating system and 5GNR network applications like PDCP, SDAP, and RRC. Transceivers in DU 712 are coupled to transceivers in RU 711 over front-haul links. Transceivers in DU 712 are coupled to transceivers in CU 713 over mid-haul links.

RLC functions comprise ARQ, sequence numbering and resequencing, segmentation and resegmentation. MAC functions comprise buffer status, power control, channel quality, HARQ, user identification, random access, user scheduling, and QoS. PHY functions comprise packet formation/deformation, guard-insertion/guard-deletion, parsing/de-parsing, control insertion/removal, interleaving/de-interleaving, FEC encoding/decoding, channel coding/decoding, channel estimation/equalization, and rate matching/de-matching, scrambling/descrambling, modulation mapping/de-mapping, layer mapping/de-mapping, precoding, RE mapping/de-mapping, FFTs/IFFTs, and DFTs/IDFTs. PDCP functions include security ciphering, header compression and decompression, sequence numbering and re-sequencing, de-duplication. SDAP functions include QoS marking and flow control. RRC functions include authentication, security, handover control, status reporting, QoS, network broadcasts and pages, and network selection.

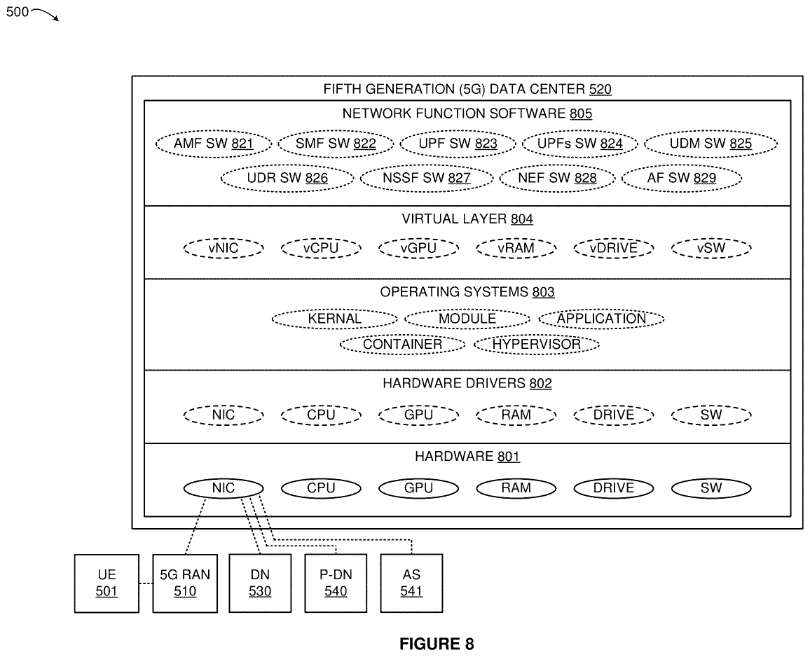

FIG. 8 illustrates 5G data center 520 in 5G communication network 500. 5G data center 520 comprises an example of core network 120 illustrated in FIG. 1, although core network 120 may differ. 5G data center 520 typically comprise a virtualized computing architecture like NFVI, but may comprise another computing architecture like a cloud computing network, a hybrid cloud network, and the like. 5G data center 520 comprises hardware 801, hardware drivers 802, operating systems 803, virtual layer 804, and network function software 805. Hardware 801 comprises Network Interface Cards (NICs), CPU, GPU, RAM, Flash/Disk Drives (DRIVE), and Data Switches (SW). Hardware drivers 802 comprises software that is resident in the NIC, CPU, GPU, RAM, DRIVE, and SW. Operating systems 803 comprise kernels, modules, applications, containers, hypervisors, and the like. Virtual layer 804 comprises vNIC, vCPU, vGPU, vRAM, vDRIVE, and vSW. Network function software 805 comprises AMF Software (SW) 821, SMF SW 822, UPF SW 823, UPFs SW 824, UDM SW 825, UDR SW 826, NSSF SW 827, NEF SW 828, and AF SW 829. Additional network function software for network functions like AUSF, PCF, CHF, HSS, HLR, NRF, SMSF, EIR, and SCP is typically present but is omitted for clarity. 5G data center 520 may be located at a single site or be distributed across multiple geographic locations. The NIC in hardware 801 is coupled to 5G RAN 510, data network (DN) 530, private data network (P-DN) 540, AS 441, and to external systems (not illustrated). Hardware 801 executes hardware drivers 802, operating systems 803, virtual layer 804, and network function software 805 to form AMF 521, SMF 522, UPF 523, UPFs 524, UDM 525, UDR 526, NSSF 527, NEF 528, and AF 529.

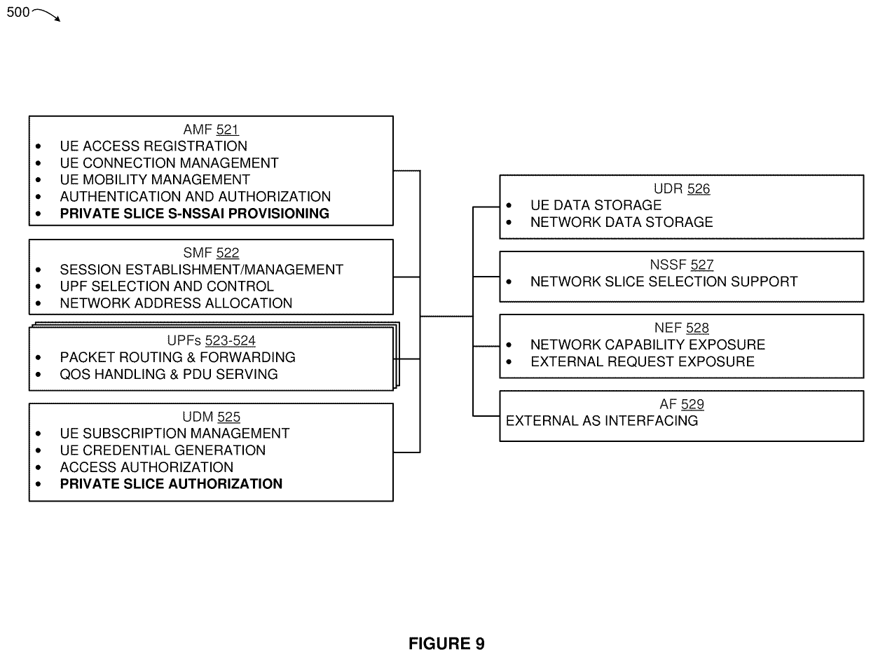

FIG. 9 further illustrates 5G data center 520 in 5G communication network 500. AMF 521 comprises capabilities for UE access registration, UE connection management, UE mobility management, UE authentication, UE authorization, and private slice S-NSSAI provisioning. SMF 522 comprises capabilities for session establishment, session management, UPF selection, UPF control, and network address allocation. UPFs 523 and 524 comprise capabilities for packet routing, packet forwarding, QoS handling, and PDU serving. UDM 525 comprises capabilities for UE subscription management, UE credential generation, access authorization, and private slice authorization. UDR 526 comprises capabilities for UE data storage and network data storage. NSSF 527 comprises capabilities for network slice selection support. NEF 528 comprises capabilities for network capability exposure and external request exposure. AF 529 comprises capabilities for external AS interfacing.

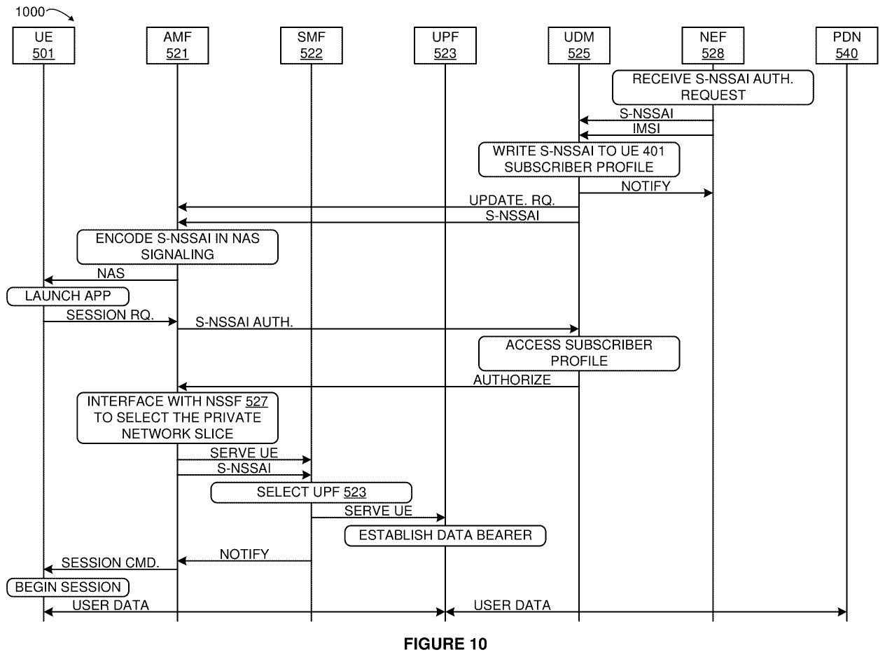

FIG. 10 illustrates process 1000. Process 1000 comprises an exemplary operation of 5G communication network 1000 to provision user devices to use private network slices. Process 1000 comprises an example of process 200 illustrated in FIG. 2, process 300 illustrated in FIG. 3, and process 400 illustrated in FIG. 4, however processes 200, 300, and 400 may differ. Process 1000 may vary in other examples. In some examples, NEF 528 receives an S-NSSAI authorization request from AS 541 over AF 529. The request includes the S-NSSAI for the private network slice and the IMSI for UE 501. NEF 528 exposes the request to UDM 525. UDM 525 accesses the subscriber profile of UE 501 stored by UDR 526 based on the IMSI. UDM 525 writes the S-NSSAI for the private network slice to the list of allowed S-NSSAI included in the subscriber profile. UDM 525 transfers an S-NSSAI update notification for UE 501 to NEF 528. UDM 525 transfers an S-NSSAI update request for UE 501 and the S-NSSAI for the private network slice to AMF 521. In response, NEF 528 may expose the indication to AS 541 over AF 529 to indicate UE 501 is authorized to use the private network slice.

AMF 521 receives the request and generates NAS signaling that encodes the S-NSSAI for the private network slice. AMF 521 transfers the NAS signaling to UE 501 to notify UE 501 that it is authorized to use the S-NSSAI for the private network slice. In doing so, 5G communication network 500 enables UE 501 to access private data network (PDN) 540 without having to provision UE 501 with the DNN for private data network 540 since the private network slice provides a connection to private data network 540 (e.g., UPF 523 of the private network slice may have a permanent connection with private data network 540). UE 501 receives the NAS signaling and identifies the S-NSSAI for the private network slice.

UE 501 launches a user application and transfers a PDU session request to AMF 521. The session request includes the S-NSSAI for the private network slice. AMF 521 interfaces with UDM 525 to authorize the S-NSSAI requested by UE 501. UDM 527 access UE 501's subscriber profile, compares the requested S-NSSAI to the list of allowed S-NSSAIs in the subscriber profile, authorizes the requested S-NSSAI based on the comparison, and indicates the authorization to AMF 521. AMF 521 interfaces with NSSF 527 to select the private network slice. AMF 521 provides the authorized S-NSSAI to NSSF 527. NSSF 527 maps the requested S-NSSAI to the private network slice and provides the slice instance ID for the private network slice to AMF 521. In response to S-NSSAI authorization and slice selection, AMF 521 directs SMF 522 to serve UE 501 and indicates the slice instance ID for the private network slice to SMF 522. SMF 522 selects UPF 523 based on the slice instance ID and directs UPF 523 to serve UE 501. SMF 522 notifies AMF 521 that the session is ready to begin and indicates the address of UPF 523 to AMF 521. AMF 521 provides the address for UPF 523 to UE 501 and directs UE 501 to begin the session. UE 501 begins its PDU session and exchanges user data with UPF 523 in the private network slice. UPF 523 exchanges the user data with private data network 540.

The wireless data network circuitry described above comprises computer hardware and software that form special-purpose network circuitry to provision user devices to use private network slices. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose network circuitry to provision user devices to use private network slices.

Although the descriptions provided herein may be in the context of certain radio access technologies, networks, and network topologies, such as 5GNR mobile communications, the proposed concepts, schemes, and any variations thereof may be implemented in, for and by other types of radio access technologies, networks, and network topologies. Such radio access technologies, networks, and network topologies may include, for example and without limitation, LTE, Internet-of-Things (IoT), NB-IoT, Vehicle-to-Everything (V2X), fixed wireless internet, and Non-Terrestrial Network (NTN) communications. Thus, the scope of the disclosure is not limited to the examples described herein.

The above description and associated figures teach the best mode of the invention. For the purpose of teaching inventive principles, some conventional aspects of the best mode may be simplified or omitted. The following claims specify the scope of the invention. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described above, nor the best mode, but only by the claims and their equivalents.

What is claimed is:

1. A method comprising:
receiving a slice authorization request for a user device of a wireless communication network from a private data network;
updating a subscriber profile of the user device to authorize the user device to use a private network slice associated with the private data network based on the slice authorization request; and
indicating the slice Identifier (ID) for the private network slice to the user device.

2. The method of claim 1 wherein the private network slice comprises one or more user plane network elements and one or more Radio Access Network (RAN) that provide a data link to the private data network.

3. The method of claim 1 further comprising:
receiving a session request that includes the slice ID for the private network slice for the user device;
accessing the subscriber profile of the user device;
authorizing the user device to use the slice ID for the private network slice based on the subscriber profile; and
routing user data of a data session between the user device and the private data network over the private network slice.

4. The method of claim 3 further comprising mapping the slice ID for the private network slice to a slice instance of the private network slice in the wireless communication network.

5. The method of claim 1 wherein:
indicating the slice ID for the private network slice to the user device comprises transferring Non-Access Stratum (NAS) signaling that encodes the slice ID to a wireless access node; and
the wireless access node wirelessly transfers the NAS signaling to the user device.

6. The method of claim 1 wherein updating the subscriber profile of the user device to authorize the user device to use the private network slice associated with the private data network based on the slice authorization request comprising adding the slice ID for private network slice to a list of allowed slice IDs included in the subscriber profile.

7. The method of claim 1 wherein the slice ID comprises a Single-Network Slice Selection Assistance Information (S-NSSAI).

8. A method comprising:
receiving, by a Network Exposure Function (NEF), a slice authorization request for a user device from an Application Server (AS) associated with a private data network over an Application Function (AF);
exposing, by the NEF, the slice authorization request to a Unified Data Management (UDM);
updating, by the UDM, a subscriber profile of the user device to authorize the user device to use a private network slice associated with the private data network based on the slice authorization request; and
indicating, by an Access and Mobility Management Function (AMF), a slice Identifier (ID) for the private network slice to the user device.

9. The method of claim 8 wherein the private network slice comprises one or more user plane network elements and one or more Radio Access Network (RAN) that provide a data link to the private data network.

10. The method of claim 8 further comprising:
receiving, by the AMF, a session request that includes the slice ID for the private network slice for the user device;
interfacing, by the AMF, with the UDM to authorize the user device to use the slice ID;
mapping, by a Network Slice Selection Function (NSSF), the slice ID to the private network slice;
directing, by the AMF, a Session Management Function (SMF) to establish a data session for the user device over the private network slice; and
selecting, by the SMF, a User Plane Function (UPF) of the private network slice to support the data session; and wherein:
the user device exchanges user data for the data session with the private data network over an access node and the UPF of the private network slice.

11. The method of claim 10 wherein interfacing, by the AMF, with the UDM to authorize the user device to use the slice ID comprises:
transferring, by the AMF, a slice authorization request for the slice ID to the UDM;
accessing, by the UDM, the subscriber profile of the user device;
comparing, by the UDM, the slice ID to a list of authorized slice IDs included in the subscriber profile to authorize the user device to use the slice ID; and
transferring, by the UDM, a slice authorization response to the AMF that indicates the user device is authorized to use the slice ID.

12. The method of claim 8 wherein:
indicating, by the AMF, the slice ID for the private network slice to the user device comprises transferring, by the AMF, Non-Access Stratum (NAS) signaling that encodes the slice ID to a wireless access node; and
the wireless access node wirelessly transfers the NAS signaling to the user device.

13. The method of claim 8 further comprising:
storing, by a Unified Data Registry (UDR), the subscriber profile for the user device; and
identifying, by the UDM, the subscriber profile based on a subscriber ID for the user device; and wherein:
updating, by the UDM, the subscriber profile of the user device to authorize the user device to use the private network slice associated with the private data network based on the slice authorization request comprises writing an authorization for the slice ID to the subscriber profile.

14. The method of claim 8 wherein the slice ID comprises a Single-Network Slice Selection Assistance Information (S-NSSAI).

15. A system comprising:
an Access and Mobility Management Function (AMF), a Unified Data Management (UDM), a Network Exposure Function (NEF), and an Application Function (AF) of a wireless communication network;
the NEF configured to:
receive a slice authorization request for a user device from an Application Server (AS) associated with a private data network over an AF; and
expose the slice authorization request to the UDM;
the UDM configured to:
update a subscriber profile of the user device to authorize the user device to use a private network slice associated with the private data network based on the slice authorization request; and
the AMF configured to:
indicate a slice Identifier (ID) for the private network slice to the user device.

16. The system of claim 15 wherein the private network slice comprises one or more user plane network elements and one or more Radio Access Network (RAN) that provide a data link to the private data network.

17. The system of claim 15 further comprising a Network Slice Selection Function (NSSF), a Session Management Function, and a User Plane Function (UPF) of the wireless communication network; and wherein:
the AMF is further configured to:
receive a session request that includes the slice ID for the private network slice for the user device; and
interface with the UDM to authorize the user device to use the slice ID;
the NSSF is configured to:
map the slice ID to the private network slice;
the AMF is further configured to:
direct the SMF to establish a data session for the user device over the private network slice; and
the SMF is configured to:
select the UPF of the private network slice to support the data session; and
the user device exchanges user data for the data session with the private data network over an access node and the UPF of the private network slice.

18. The system of claim 17 wherein:
the AMF is further configured to transfer a slice authorization request for the slice ID to the UDM to interface with the UDM to authorize the user device to use the slice ID; and
the UDM is further configured to:
access the subscriber profile of the user device;
compare the slice ID to a list of authorized slice IDs included in the subscriber profile to authorize the user device to use the slice ID; and
transfer a slice authorization response to the AMF that indicates the user device is authorized to use the slice ID.

19. The system of claim 15 wherein:
the AMF is further configured to transfer Non-Access Stratum (NAS) signaling that encodes the slice ID to a wireless access node to indicate the slice ID for the private network slice to the user device; and
the wireless access node wirelessly transfers the NAS signaling to the user device.

20. The system of claim 15 further comprising a Unified Data Registry (UDR); and wherein:
the UDR is configured to store the subscriber profile for the user device; and
the UDM is further configured to:
identify the subscriber profile based on a subscriber ID for the user device; and
write an authorization for the slice ID to the subscriber profile to update the subscriber profile of the user device to authorize the user device to use the private network slice associated with the private data network.
